(19) United States
(12) Patent Application Publication
(10) Pub. No.: US 2025/0114856 A1
(43) Pub. Date: Apr. 10, 2025

(54) METHOD FOR CONTROLLING A POWER BEAM PROCESS

(71) Applicant: ROLLS-ROYCE plc, London (GB)

(72) Inventors: Alistair J E SMITH, Nottingham (GB); Kee Khoon Lee, Derby (GB); Henry KASIM, Derby (GB); Teck Kai CHAN, Derby (GB)

(73) Assignee: ROLLS-ROYCE plc, London (GB)

(21) Appl. No.: 18/826,809

(22) Filed: Sep. 6, 2024

(30) Foreign Application Priority Data
Oct. 6, 2023 (GB) 2315357.0

(51) Int. Cl. B23K 15/02; G05B 19/4155

(52) U.S. Cl. CPC B23K 15/02; G05B 19/4155; G05B 2219/45138

(57) ABSTRACT

A method for controlling a power beam process includes carrying out a plurality of test power beam processes using a power beam on one or more test components and determining a plurality of power distributions corresponding to the plurality of test power beam processes. The method includes determining a plurality of beam parameters, generating derived features based on the plurality of beam parameters, and determining a plurality of process characteristics of each test power beam process. The method further includes generating a comprehensive dataset, dividing the comprehensive dataset into a test dataset and a training dataset, and determining a plurality of key discriminative features from the plurality of derived features of a set of training power distributions of the training dataset.

### CROSS-REFERENCE TO RELATED APPLICATIONS

This specification is based upon and claims the benefit of priority from United Kingdom patent application number GB 2315357.0 filed on Oct. 6, 2023, the entire contents of which is incorporated herein by reference.

### BACKGROUND

### Technical Field

The present disclosure relates to a method for controlling a power beam process, a computing device, and a non-transitory computer-readable storage medium.

### Description of the Related Art

A power beam process, for example, an electron beam welding process, may offer significantly greater depth of penetration as compared to a conventional arc welding process. Further, the power beam process may offer precise control over a power beam which may provide accurate and controlled heat during the power beam process. The power beam processes are highly automated processes and hence require consistency to be maintained. Various parameters, such as an overall power, a beam diameter, and a power distribution of the power beam may contribute to a repeatability of the power beam process. Currently, these parameters may be verified through process control test pieces over which the power beam is passed using a fixed set of parameters and the resulting process control test pieces are assessed. Similarly, to validate the parameters for a particular application, a series of trials are carried out on the process control test pieces before a final validation on a representative sample. Further, each machine performing the power beam process is considered unique and therefore requires its own validation.

Data collected from various measuring systems may be only used to monitor the power beam process as there is limited understanding of which specific features lead to a good quality power beam process. The power beam process experts may therefore be unable to define precise thresholds for an optimal power beam process performance. This may lead to a need to continue with verifying the parameters through the process control test pieces, validating the parameters, and calibrating each machine performing the power beam process to control the power beam process. This may require a significant time and a significant operating cost.

### SUMMARY

According to a first aspect, there is provided a method for controlling a power beam process. The method includes carrying out a plurality of test power beam processes using a power beam on one or more test components. The method further includes determining a plurality of power distributions of the power beam corresponding to the plurality of test power beam processes. Each of the plurality of power distributions is a distribution of a beam intensity of the power beam with respect to a distance from the centre of the power beam. The method further includes determining a plurality of beam parameters of the power beam corresponding to each of the plurality of power distribution and generating a plurality of derived features for each of the plurality of power distributions based on the plurality of beam parameters of the corresponding power distribution. Each of the plurality of derived features is obtained by combining two or more of the plurality of beam parameters of the corresponding power distribution. The method further includes determining a plurality of process characteristics of each of the plurality of test power beam processes and classifying each of the plurality of power distributions into one of a plurality of predetermined quality indicators based on the plurality of process characteristics of the corresponding test power beam process. The method further includes generating a comprehensive dataset by consolidating the plurality of power distributions with the corresponding plurality of derived features, the corresponding plurality of beam parameters, the corresponding plurality of process characteristics, and the corresponding predetermined quality indicator. The method further includes dividing the comprehensive dataset into a test dataset and a training dataset that is mutually exclusive from the test dataset. The test dataset includes a set of test power distributions from the plurality of power distributions and the training dataset includes a set of training power distributions from the plurality of power distributions. The method further includes determining a plurality of key discriminative features from the plurality of derived features of the set of training power distributions. The method further includes receiving a plurality of input key discriminative features and classifying each of the plurality of input key discriminative features into one of the plurality of predetermined quality indicators. The method further includes controlling the power beam process based on the predetermined quality indicator of each of the plurality of input key discriminative features.

The method includes determining the plurality of key discriminative features which can correlate with the process characteristics in a different and a more accurate manner. Specifically, the plurality of key discriminative features may be features that are effective in discriminating between different qualities of the power beam processes, for example, good welds and bad welds. In other words, the plurality of key discriminative features may be able to classify the power beam process into one of the plurality of predetermined quality indicators. A user or an operator may then set the control parameters (e.g., the beam parameters) accordingly. Therefore, the method may provide repeatability to the power beam process. In other words, a verification and a validation through process control test pieces may not be required. Therefore, the method may provide control of the power beam process at the point of use rather than reliance of periodic tests and measurements using the process control test pieces. This may reduce significant time and operational cost of carrying out the power beam process.

In some embodiments, the plurality of predetermined quality indicators includes at least a good quality indicator and a poor quality indicator. The method further includes dividing the set of test power distributions into a plurality of subsets of test power distributions, such that each of the plurality of subsets of test power distributions includes at least one test power distribution having the poor quality indicator as the predetermined quality indicator. Such division of the set of test power distributions may ensure that the set of test power distributions may be able to test a performance of a predictive model without any bias towards the good quality indicators.

In some embodiments, determining the plurality of key discriminative features further includes dividing the set of training power distributions into a plurality of subsets of training power distributions. Each of the plurality of subsets of training power distribution has the plurality of derived features of the corresponding training power distributions. Determining the plurality of key discriminative features further includes determining a set of discriminative features from the plurality of derived features of each of the plurality of subsets of training power distributions by performing descriptive analytics on the plurality of derived features of the corresponding subset of training power distributions. Each set of discriminative features includes a plurality of discriminative features selected from the plurality of derived features. Determining the plurality of key discriminative features further includes selecting a predefined number of the discriminative features from each set of discriminative features based on a number of occurrences of the plurality of discriminative features in the corresponding set of discriminative features and collating the selected discriminative features from each set of discriminative features to form the plurality of key discriminative features. Thus, the method may leverage on descriptive analytics to determine and select the plurality of key discriminative features from the plurality of derived features. Further, such selected discriminative features may have a greater correlation with the plurality of predetermined quality indicators.

In some embodiments, the method further includes training a predictive model by using the plurality of key discriminative features of the set of training power distributions and validating the trained predictive model by using the set of test power distributions. Thus, the method may also be used to train the predictive model using the training dataset and validate the trained predictive model by using the test dataset. Since the training dataset is mutually exclusive from the test dataset, the validation may be accurate and without any bias.

In some embodiments, validating the trained predictive model further includes providing the test dataset to the trained predictive model; classifying, via the trained predictive model, each value of the plurality of key discriminative features of the test power distribution of the set of test power distributions into one of the plurality of predetermined quality indicators; and validating the trained predictive model by comparing, for each of the test power distributions, the predetermined quality indicator classified by the trained predictive model with the predetermined quality indicator in the test dataset. Thus, the trained predictive model may be validated by comparing the predicted quality results, i.e., the predetermined quality indicator classified by the trained predictive model with the actual quality results, i.e., the predetermined quality indicator in the test dataset.

In some embodiments, validating the trained predictive model further includes using at least one evaluation criteria to determine a performance of the trained predictive model. This may help the user to evaluate if the trained predictive model is reliable, i.e., if the trained predictive model will be able to provide a desired accuracy and/or repeatability.

In some embodiments, each of the plurality of input key discriminative features is classified into one of the plurality of predetermined quality indicators by using the validated predictive model. Therefore, the trained predictive model may provide quick results, i.e., the plurality of predetermined quality indicators. This may allow quick control of the power beam process without using any process control test pieces.

In some embodiments, a focus current or a working distance of the power beam is different across the plurality of test power beam processes. Accordingly, the plurality of beam parameters of the power beam may be different across the plurality of test power beam processes. Therefore, the plurality of power distributions of the power beam corresponding to the plurality of test power beam processes may be different from each other and a comprehensive data may be generated which may help in determining the key discriminative features more accurately.

In some embodiments, the plurality of beam parameters includes at least one of a Full Width Half Maximum (FWHM) of the power beam, a peak power of the power beam, a beam diameter of the power beam, a beam area of the power beam, a beam intensity of the power beam, a beam angle of the power beam, and a beam circularity of the power beam. Therefore, a large number of beam parameters of the power beam may be determined and consolidated in the comprehensive dataset to determine the key discriminative features more accurately.

In some embodiments, the method further includes generating a graphical representation of at least one of the plurality of key discriminative features indicating the predetermined quality indicators of the corresponding training power distributions and determining one or more planes that separate the graphical representation into a plurality of regions including a majority of the corresponding predetermined quality indicators. In some cases, the values of plurality of key discriminative features are indicated with the corresponding predetermined quality indicators. For example, different colour and/or shape may be used to indicate the corresponding predetermined quality indicators. Therefore, the graphical representation may provide the user with a visualization ability. The graphical representation may facilitate the user/operator to easily understand a correlation between the values of the key discriminative features and the predetermined quality indicators.

In some embodiments, each of the plurality of input key discriminative features is classified into one of the plurality of predetermined quality indicators by using the one or more planes. Therefore, the user may be able to identify the classified plurality of predetermined quality indicators for each of the plurality of input key discriminative features with the help of the one or more planes of the graphical representation.

In some embodiments, the method further includes determining one or more optimal values for the at least one of the plurality of key discriminative features based on the one or more planes. Therefore, the optimal values may be selected for the at least one of the plurality of key discriminative features and used to classify the future samples into one of the plurality of predetermined quality indicators.

In some embodiments, the method includes cleaning the comprehensive dataset prior to dividing the comprehensive dataset into the test dataset and the training dataset. Cleaning the comprehensive dataset includes removing duplicate power distributions from the plurality of power distributions. Therefore, the comprehensive dataset may be complete and accurate and may help to determine the key discriminative features more accurately.

In some embodiments, generating the comprehensive dataset further includes consolidating the plurality of power distributions with a corresponding timestamp of the corresponding test power beam process. Therefore, the comprehensive dataset may also include a corresponding date and/or time of when the plurality of test power beam processes are carried out.

In some embodiments, the power beam is an electron beam.

In some embodiments, the power beam process is an electron beam welding process.

In some embodiments, the plurality of process characteristics includes at least one of a weld depth and a weld width.

According to a second aspect, there is provided a computing device including a processor and a memory having stored therein a plurality of instructions that when executed by the processor causes the computing device to perform the method of the first aspect.

According to a third aspect, there is provided a non-transitory computer-readable storage medium including instructions that, when executed, cause at least one processor to perform the method of the first aspect.

The term “test component” as used herein means any component that is suitable to be tested using the method of the present disclosure. The test component may be a production component or a non-saleable component. The test component may be a component of a gas turbine engine or a sample or part thereof. The test component may be an electrical component or a sample or part thereof. The test component may be a metal strip.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 illustrates a schematic block diagram of a control system used for controlling a power beam process;

FIG. 2A illustrates a flowchart of a method for controlling the power beam process;

FIG. 2B illustrates a flowchart of a method for controlling the power beam process;

FIG. 3 illustrates an exemplary process flow of the method;

FIG. 4 illustrates an exemplary power distribution of a power beam;

FIG. 5 illustrates an exemplary test component;

FIG. 6 illustrates an exemplary comprehensive dataset;

FIG. 7A illustrates a schematic block diagram of a predictive model;

FIG. 7B illustrates a schematic block diagram of a trained predictive model;

FIG. 7C illustrates a schematic block diagram of a validated predictive model; and

FIG. 8 illustrates an exemplary graphical representation.

### DETAILED DESCRIPTION

Aspects and embodiments of the present disclosure will now be discussed with reference to the accompanying figures. Further aspects and embodiments will be apparent to those skilled in the art.

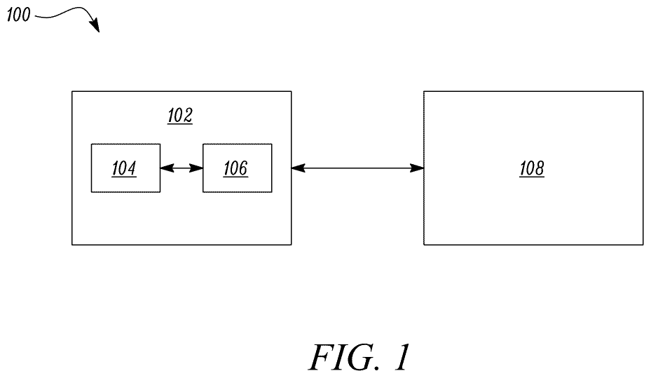

FIG. 1 shows a schematic block diagram of a control system 100 used for controlling a power beam process which uses a power beam. In some embodiments, the power beam process is an electron beam welding process. In some embodiments, the power beam is an electron beam. In some embodiments, the power beam process is a laser beam welding process. In some embodiments, the power beam is a laser beam. In some embodiments, the power beam process is a deposition process, a cutting process, a melting process, and the like. In some embodiments, the power beam process may be used for processing (e.g., welding) different components of a gas turbine engine (not shown) and/or electrical components (not shown).

Referring to FIG. 1, the control system 100 includes a computing device 102 and a process apparatus 108 for performing the power beam process. The computing device 102 is communicably coupled to the process apparatus 108.

The computing device 102 includes a processor 104 and a memory 106. The processor 104 and the memory 106 are communicably coupled to each other. The memory 106 is configured to store therein a plurality of instructions that when executed by the processor 104 causes the computing device 102 to perform one or more operations disclosed herein. In some embodiments, the computing device 102 may also include a user interface (not shown) communicably coupled to the processor 104. The user interface may include an input device and/or an output device. In some examples, the user interface may include a keyboard, a mouse, a display, and the like. A user or an operator may interact with the user interface to enter an input information or to obtain an output information.

The process apparatus 108 may carry out the power beam process based on the instructions received from the computing device 102. The process apparatus 108 may include one or more components that may be required to carry out the power beam process. In some embodiments, the one or more components may include a power beam emitter, a control mechanism for the power beam emitter, a power supply, a chamber, and the like.

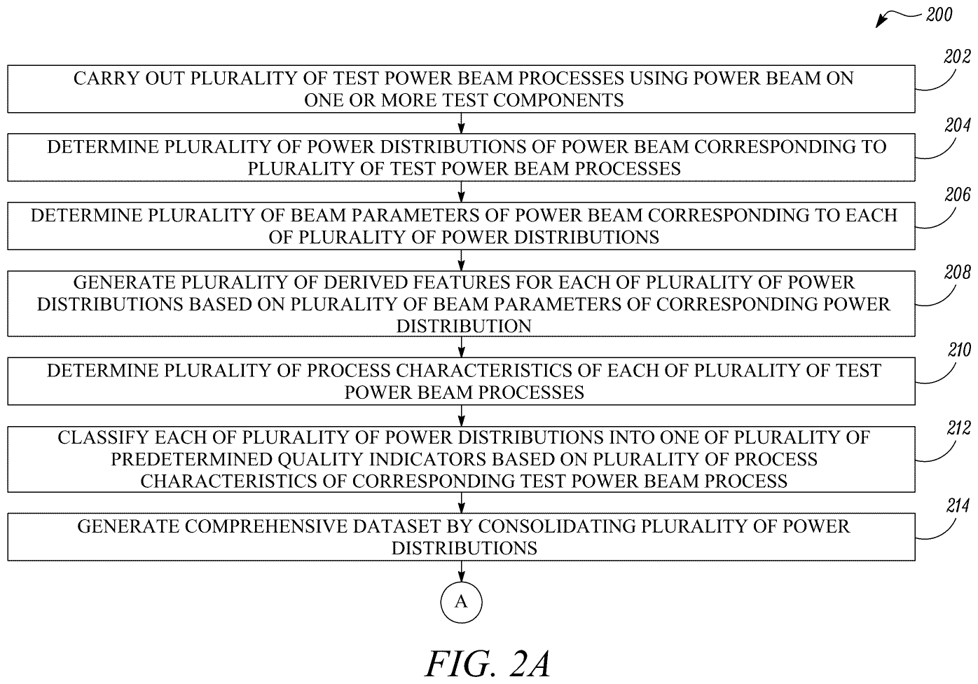

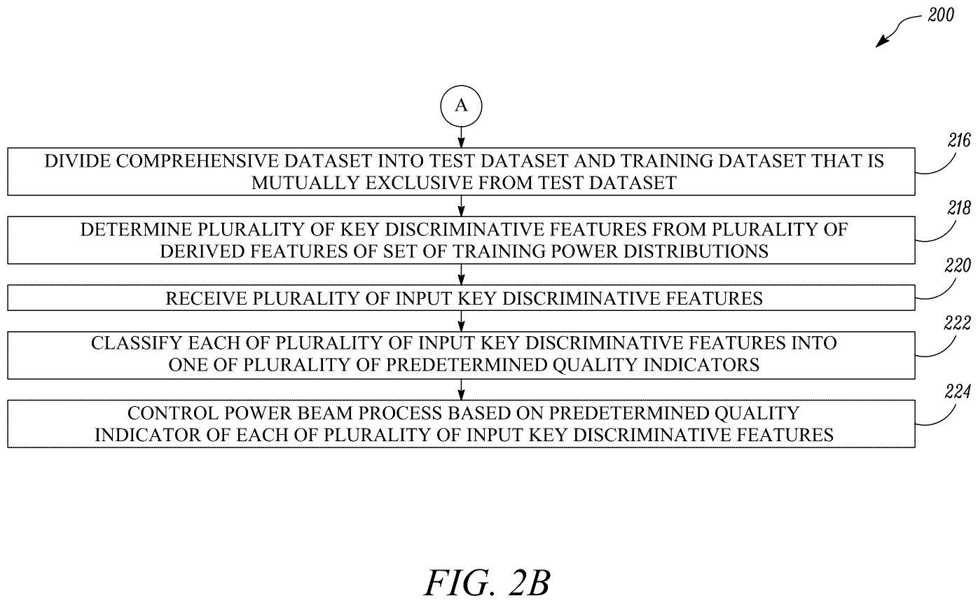

FIGS. 2A and 2B show a flowchart of a method 200 for controlling the power beam process.

At step 202, the method 200 includes carrying out a plurality of test power beam processes using the power beam on one or more test components, which may be for example one or more production components or one or more non-saleable components. In some embodiments, the one or more test components may be one or more metal strips. In some cases, the one or more test components may be components of a gas turbine and/or may be electrical components. In some cases, the one or more test components may be one or more samples of the components of the gas turbine and/or the electrical components.

At step 204, the method 200 includes determining a plurality of power distributions of the power beam corresponding to the plurality of test power beam processes. Each of the plurality of power distributions is a distribution of a beam intensity of the power beam with respect to a distance from a centre of the power beam. In some embodiments, a focus current or a working distance of the power beam is different across the plurality of test power beam processes. Therefore, the plurality of power distributions of the power beam corresponding to the plurality of test power beam processes may be different from each other.

At step 206, the method 200 includes determining a plurality of beam parameters of the power beam corresponding to each of the plurality of power distributions. In some embodiments, the plurality of beam parameters includes at least one of a Full Width Half Maximum (FWHM) of the power beam, a peak power of the power beam, a beam diameter of the power beam, a beam area of the power beam, a beam intensity of the power beam, a beam angle of the power beam, and a beam circularity of the power beam. In some embodiments, the plurality of beam parameters may include other beam parameters that may be derived from the power distributions. Therefore, a large number of beam parameters of the power beam may be determined and considered for controlling the power beam process.

At step 208, the method 200 includes generating a plurality of derived features for each of the plurality of power distributions based on the plurality of beam parameters of the corresponding power distribution. Each of the plurality of derived features is obtained by combining two or more of the plurality of beam parameters of the corresponding power distribution. In some examples, the plurality of derived features may be different ratios, sums, or differences of the two or more of the plurality of beam parameters of the corresponding power distribution.

At step 210, the method 200 includes determining a plurality of process characteristics of each of the plurality of test power beam processes. In some examples, the plurality of process characteristics includes at least one of a weld depth and a weld width. In some examples, the plurality of process characteristics may be determined by performing various measurements on the one or more test components after carrying out the plurality of test power beam processes. In some embodiments, the plurality of process characteristics may be determined by visual inspection of the one or more test components after carrying out the plurality of test power beam processes.

At step 212, the method 200 includes classifying each of the plurality of power distributions into one of a plurality of predetermined quality indicators based on the plurality of process characteristics of the corresponding test power beam process. Each of the plurality of predetermined quality indicators may correspond to a quality of a test power beam process from the plurality of test power beam processes. In some embodiments, the plurality of predetermined quality indicators includes at least a good quality indicator and a bad quality indicator. In case the test power beam process is the electron beam welding process or the laser beam welding process, the predetermined quality indicator may include a good weld indicator or a poor weld indicator. In some embodiments, the plurality of predetermined quality indicators may include a quality rating or a quality score.

At step 214, the method 200 includes generating a comprehensive dataset by consolidating the plurality of power distributions with the corresponding plurality of derived features, the corresponding plurality of beam parameters, the corresponding plurality of process characteristics, and the corresponding predetermined quality indicator. In some embodiments, the comprehensive dataset is stored in a memory (e.g., the memory 106 of the computing device 102 shown in FIG. 1).

In some embodiments, generating the comprehensive dataset further includes consolidating the plurality of power distributions with a corresponding timestamp of the corresponding test power beam process. In some embodiments, the timestamp may include a date and/or a time of carrying out the corresponding test power beam process. In some embodiments, generating the comprehensive dataset may further include annotating one or more conditions (e.g., environmental conditions) of the test power beam processes with the respective test power beam processes.

At step 216, the method 200 includes dividing the comprehensive dataset into a test dataset and a training dataset that is mutually exclusive from the test dataset. The test dataset includes a set of test power distributions from the plurality of power distributions and the training dataset includes a set of training power distributions from the plurality of power distributions.

In some embodiments, the method 200 includes dividing the set of test power distributions into a plurality of subsets of test power distributions, such that each of the plurality of subsets of test power distributions includes at least one test power distribution having the poor quality indicator as the predetermined quality indicator.

In some embodiments, the method 200 further includes cleaning the comprehensive dataset prior to dividing the comprehensive dataset into the test dataset and the training dataset. In some embodiments, cleaning the comprehensive dataset includes removing duplicate power distributions from the plurality of power distributions. In some embodiments, cleaning the comprehensive dataset may include removing the test power beam processes having incorrect data, the test power beam processes having incomplete data, the test power beam processes having corrupted data, and/or the test power beam processes having incorrectly formatted data from the comprehensive dataset.

At step 218, the method 200 includes determining a plurality of key discriminative features from the plurality of derived features of the set of training power distribution. The plurality of key discriminative features may correlate with the process characteristics in a different and a more accurate manner. Specifically, the plurality of key discriminative features may be features that are effective in discriminating between different qualities of the power beam processes, for example, good welds and bad welds. In other words, the plurality of key discriminative features may be able to classify the power beam process into one of the plurality of predetermined quality indicators.

In some embodiments, determining the plurality of key discriminative features further includes dividing the set of training power distributions into a plurality of subsets of training power distributions. Each of the plurality of subsets of training power distribution has the plurality of derived features of the corresponding training power distributions. In some embodiments, determining the plurality of key discriminative features further includes determining a set of discriminative features from the plurality of derived features of each of the plurality of subsets of training power distributions by performing descriptive analytics on the plurality of derived features of the corresponding subset of training power distributions. Each set of discriminative features includes a plurality of discriminative features selected from the plurality of derived features.

In some embodiments, determining the plurality of key discriminative features further includes selecting a predefined number of the discriminative features from each set of discriminative features based on a number of occurrences of the plurality of discriminative features in the corresponding set of discriminative features and collating the selected discriminative features from each set of discriminative features to form the plurality of key discriminative features. For instance, five of the discriminative features from each set of discriminative features may be selected based on the number of occurrences of the plurality of discriminative features in the corresponding set of discriminative features. Such selected discriminative features may have a greater correlation with the plurality of predetermined quality indicators.

At step 220, the method 200 further includes receiving a plurality of input key discriminative features. For example, values of the key discriminative features may be retrieved from the memory 106 shown in FIG. 1 or may be selected or provided by the user/operator via the user interface.

At step 222, the method 200 includes classifying each of the plurality of input key discriminative features into one of the plurality of predetermined quality indicators. Specifically, the method 200 includes classifying each value of the plurality of input key discriminative features into one of the plurality of predetermined quality indicators. For example, the method 200 includes classifying each value of the plurality of input key discriminative features into one of the good quality indicator and the poor quality indicator.

At step 224, the method 200 includes controlling the power beam process based on the predetermined quality indicator of each of the plurality of input key discriminative features. In other words, the method 200 includes controlling the power beam process based on the classified predetermined quality indicator of each of the plurality of input key discriminative features. The method 200 may control the power beam process more precisely and accurately according to the classified predetermined quality indicator of each of the plurality of input key discriminative features. In some embodiments, the process apparatus 108 shown in FIG. 1 may be used to control the power beam process according to the classified predetermined quality indicator of each of the plurality of input key discriminative features.

In some embodiments, the method 200 further includes training a predictive model by using the plurality of key discriminative features of the set of training power distributions. In an embodiment, the predictive model includes a decision tree classification model. In an embodiment, the predictive model includes a machine learning model, for example a decision tree classification model.

In some embodiments, the method 200 further includes validating the trained predictive model by using the set of test power distributions. In some embodiments, validating the trained predictive model further includes providing the test dataset to the trained predictive model. In some embodiments, validating the trained predictive model further includes classifying, via the trained predictive model, each value of the plurality of key discriminative features of the test power distribution of the set of test power distributions into one of the plurality of predetermined quality indicators. For example, the trained predictive model may classify each value of the plurality of key discriminative features of the test power distribution of the set of test power distributions into the good quality indicator or the poor quality indicator.

In some embodiments, validating the trained predictive model further includes validating the trained predictive model by comparing, for each of the test power distributions, the predetermined quality indicator classified by the trained predictive model with the predetermined quality indicator in the test dataset. In some embodiments, each of the plurality of input key discriminative features is classified into one of the plurality of predetermined quality indicators by using the validated predictive model. In some embodiments, validating the trained predictive model further includes using at least one evaluation criteria to determine a performance of the trained predictive model. In some embodiments, the at least one evaluation criteria may include an F1-score or an accuracy score to determine a performance or evaluate the trained predictive model.

In some embodiments, the method 200 further includes generating a graphical representation of at least one of the plurality of key discriminative features indicating the predetermined quality indicators of the corresponding training power distributions. In some embodiments, the method 200 further includes determining one or more planes that separate the graphical representation into a plurality of regions including a majority of the corresponding predetermined quality indicators. For example, one of the plurality of regions may include a majority of the good quality indicators and another of the plurality of regions may include a majority of the poor quality indicators.

In some embodiments, each of the plurality of input key discriminative features is classified into one of the plurality of predetermined quality indicators by using the one or more planes. In some embodiments, the values of different key discriminative features may be represented in different colour or different shapes. In some embodiments, different predetermined quality indicators may be indicated by different colours or shapes. Such graphical representation may facilitate the user/operator to clearly distinguish the key discriminative features that may contribute to different predetermined quality indicators.

In an embodiment, the graphical representation may be presented on the user interface, such as the display. In some embodiment, the user may select the at least one of the plurality of key discriminative features to include in the graphical representation. Therefore, the graphical representation may be an interactive representation. In some embodiments, the method 200 further includes determining one or more optimal values for the at least one of the plurality of key discriminative features based on the one or more planes.

Referring to FIGS. 1 and 2A-2B, in some embodiments, the memory 106 is configured to store therein a plurality of instructions that when executed by the processor 104 causes the computing device 102 to perform the method 200. In some embodiments, a non-transitory computer-readable storage medium (e.g., the memory 106) includes instructions that, when executed, cause at least one processor (e.g., the processor 104) to perform the method 200. The memory 106 may be interchangeably referred to as “the non-transitory computer-readable storage medium 106”.

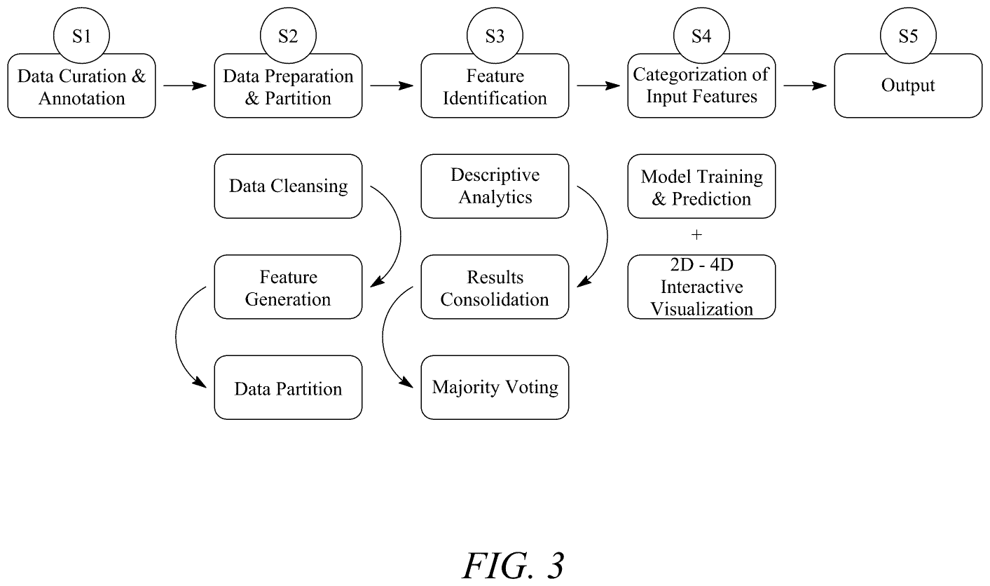

FIG. 3 shows an exemplary process flow of the method 200 shown in FIGS. 2A-2B. As shown, the method 200 may be divided into five sub-modules S1-S5.

Referring to FIGS. 2A-2B and 3, in an embodiment, the sub-module S1 is used for data curation and annotation. Specifically, the sub-module S1 performs the step 214 of the method 200. In an embodiment, the sub-module S2 is used for data preparation and partitioning. Specifically, the sub-module S2 performs the step 216 of the method 200. In an embodiment, the sub-module S3 is used for feature identification. Specifically, the sub-module S3 performs the step 218 of the method 200. In an embodiment, the sub-module S4 is used for categorization of input features. Specifically, the sub-module S4 performs the step 222 of the method 200. In an embodiment, the sub-module S5 is used for providing an output. Specifically, the sub-module S5 performs the step 224 of the method 200.

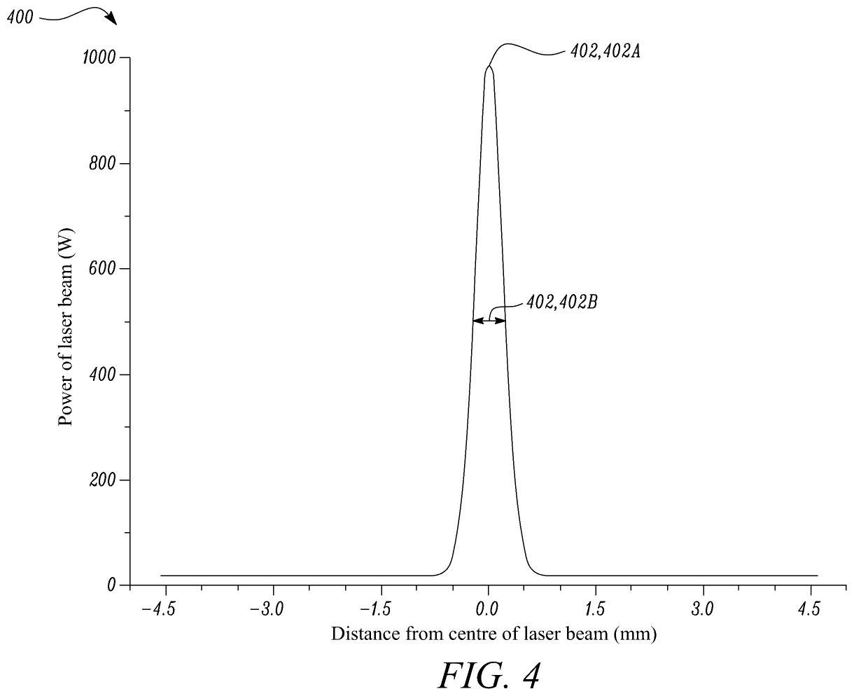

FIG. 4 shows an exemplary power distribution 400 of the beam intensity from the plurality of power distributions of the power beam. Specifically, the power distribution 400 is a distribution of the beam power with respect to the distance from the centre of the power beam. The beam power of the power beam is shown in Watts (W) in the ordinate and the distance from the centre of the power beam is shown in millimeters (mm) in the abscissa. Further, the plurality of beam parameters is depicted with reference numeral 402.

The plurality of beam parameters 402 of the power beam is determined corresponding to each of the plurality of power distributions. In some embodiments, the power distribution 400 is used to obtain the plurality of beam parameters. In the illustrated example of FIG. 4, the peak power is shown as a peak power 402A and the FWHM is shown as a FWHM 402B. The power distribution 400 may further be used to obtain the beam diameter, the beam area, the beam intensity, the beam angle, the beam circularity, and the like.

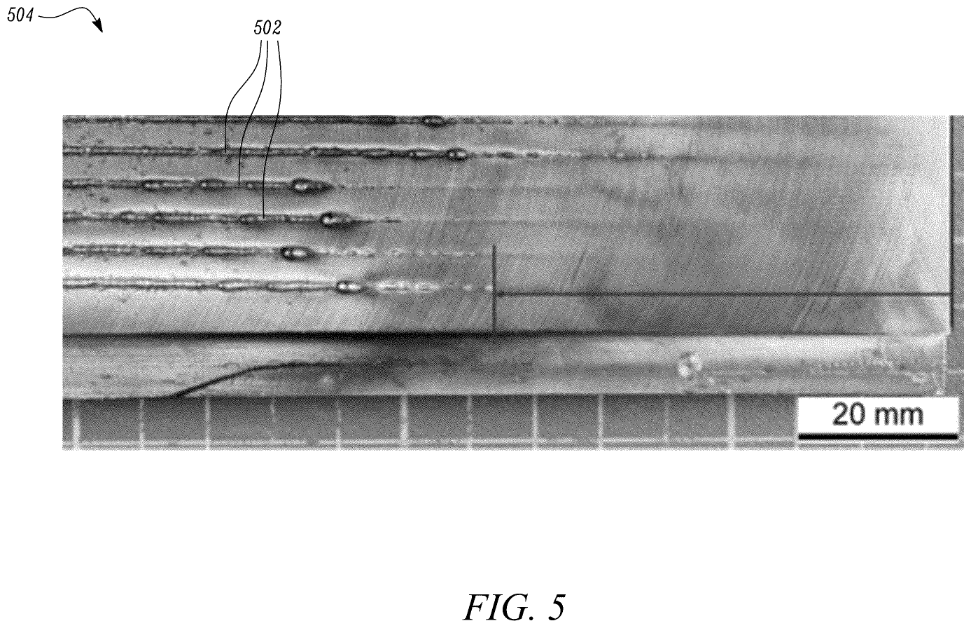

FIG. 5 illustrates an exemplary test component 504 from the one or more test components. Specifically, FIG. 5 illustrates the test component 504 after the plurality of test power beam processes has been performed thereon.

Referring to FIGS. 2A-2B and 5, the plurality of test power beam processes is carried out using the power beam on the one or more test components 504, as per the step 202 of the method 200. The plurality of test power beam processes generates a corresponding plurality of test power beam outputs 502. The plurality of process characteristics of each of the plurality of test power beam processes is determined, as per the step 210 of the method 200. The plurality of process characteristics of each of the plurality of test power beam processes may be determined by measuring physical characteristics (e.g., the weld depth and the weld width) of the corresponding plurality of test power beam outputs 502.

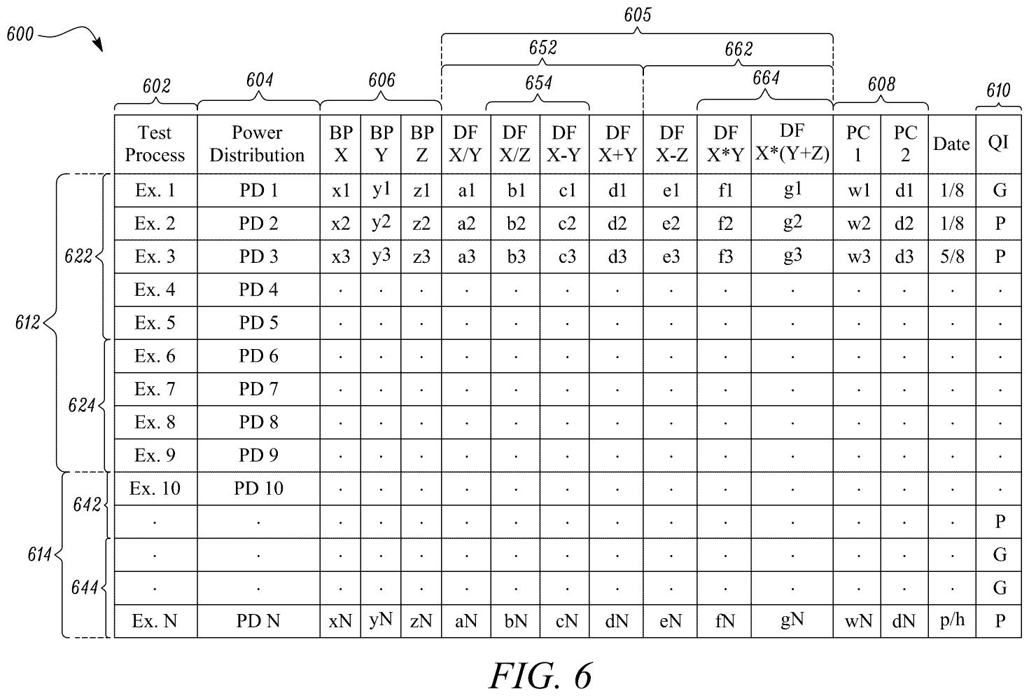

FIG. 6 shows an exemplary comprehensive dataset 600. The method 200 shown in FIGS. 2A and 2B will be described further with reference to FIG. 6. The comprehensive dataset 600 includes a plurality of test power beam processes 602 (e.g., test power beam processes Ex.1 to Ex. N).

The comprehensive dataset 600 further includes a plurality of power distributions 604 (e.g., PD 1 to PD N) corresponding to the plurality of test power beam processes 602 (e.g., test power beam processes Ex.1 to Ex. N). The plurality of power distributions 604 is determined corresponding to the plurality of test power beam processes 602, as per the step 204 of the method 200.

The comprehensive dataset 600 further includes a plurality of beam parameters 606 (e.g., BP X, BP Y, and BP Z) corresponding to each of the plurality of power distributions 604 (e.g., PD 1 to PD N). The plurality of beam parameters 606 is determined corresponding to each of the plurality of power distributions 604, as per the step 206 of the method 200. In the illustrated example of FIG. 6, three beam parameters 606 are shown. However, the plurality of beam parameters 606 may include any number of beam parameters 606 as per desired application attributes. For example, the power distribution PD 1 may have a beam parameter BP X having a value x1 and a beam parameter BP Y having a value y1, and a beam parameter BP Z having a value z1.

The comprehensive dataset 600 further includes a plurality of derived features 605 for each of the plurality of power distributions 604 based on the plurality of beam parameters 606 (e.g., BP X, BP Y, and BP Z) of the corresponding power distribution 604 (e.g., PD 1 to PD N). The plurality of derived features 605 may be different ratios, sums, or differences of the two or more of the plurality of beam parameters 606 of the corresponding power distribution 604. The plurality of derived features 605 is generated for each of the plurality of power distributions 604 based on the plurality of beam parameters 606 of the corresponding power distribution 604, as per the step 208 of the method 200.

For example, the power distribution PD 1 may have a derived feature DF X/Y having a value a1. The value a1 is a ratio of the value x1 of the beam parameter BP X to the value y1 of the beam parameter BP Y. Similarly, values of the plurality of derived features 605 for each of the plurality of power distributions 604 may be obtained. In the illustrated example of FIG. 6, seven derived features 605 are shown. However, the plurality of derived features 605 may include any number of derived features 605, as per desired application attributes.

The comprehensive dataset 600 further includes a plurality of process characteristics 608 of each of the plurality of test power beam processes 602 (e.g., test power beam processes Ex.1 to Ex. N). In some embodiments, the plurality of process characteristics 608 includes at least one of a weld depth PC 1 and a weld width PC 2. For example, the test power beam process Ex. 1 may have a first process characteristic, i.e., the weld depth PC 1 having a value w1 and a second process characteristic, i.e., the weld width PC 2 having a value d1.

Further, the comprehensive dataset 600 includes a predetermined quality indicator 610 (QI) corresponding to each of the plurality of power distributions 604. The predetermined quality indicator 610 corresponding to each of the plurality of power distributions 604 indicates a quality of the corresponding power distribution 604. In an example, the predetermined quality indicator 610 may include a good quality indicator G and a poor quality indicator P.

Each of the plurality of power distributions 604 is classified into one of the plurality of predetermined quality indicators 610 based on the plurality of process characteristics 608 of the corresponding test power beam process 602, as per the step 212 of the method 200. For example, the power distributions PD 1 is classified into the good quality indicator G based on the value w1 of PC 1 and/or the value w1 of PC 2 of the test power beam process Ex. 1. The value w1 of PC 1 and/or the value w1 of PC 2 may be process characteristics indicative of a good weld.

Therefore, the comprehensive dataset 600 is generated by consolidating the plurality of power distributions 604 with the corresponding plurality of derived features 605, the corresponding plurality of beam parameters 606, the corresponding plurality of process characteristics 608, and the corresponding predetermined quality indicator 610, as per the step 214 of the method 200. In some embodiments, the comprehensive dataset 600 is generated by consolidating the plurality of power distributions with a corresponding timestamp, such as a date and/or time of carrying out the corresponding test power beam process 602.

The comprehensive dataset 600 is further divided into a test dataset 614 and a training dataset 612 that is mutually exclusive from the test dataset 614, as per the step 216 of the method 200. The test dataset 614 includes a set of test power distributions (e.g., Ex. 10 to Ex. N) from the plurality of power distributions 604 and the training dataset 612 includes a set of training power distributions (e.g., Ex. 1 to Ex. 9) from the plurality of power distributions 604.

In some embodiments, the comprehensive dataset 600 is cleaned prior to being divided into the test dataset 614 and the training dataset 612. In some embodiments, the comprehensive dataset 600 is cleaned by removing duplicate power distributions 604 from the plurality of power distributions 604. In some embodiments, the comprehensive dataset 600 may be cleaned by removing the test power beam processes 602 having incorrect data, the test power beam processes 602 having incomplete data, the test power beam processes 602 having corrupted data, and/or the test power beam processes 602 having incorrectly formatted data from the comprehensive dataset 600.

Further, a plurality of key discriminative features 654, 664 is determined from the plurality of derived features 605 of the set of training power distributions, as per the step 218 of the method 200.

The set of training power distributions (e.g., Ex. 1 to Ex. 9) is further divided into a plurality of subsets of training power distributions 622, 624. As shown in FIG. 6, each of the plurality of subsets of training power distribution 622, 624 has the plurality of derived features of the corresponding training power distributions. A set of discriminative features 652, 662 from the plurality of derived features 605 is determined for each of the plurality of subsets of training power distributions 622, 624 by performing descriptive analytics. For example, the set of discriminative features 652 may be determined for the subset of training power distributions 622 and the set of discriminative features 662 may be determined for the subset of training power distributions 624 by performing descriptive analytics. Each set of discriminative features 652, 662 includes a plurality of discriminative features selected from the plurality of derived features 605.

Further, a predefined number of the discriminative features from each set of discriminative features 652, 662 is selected based on a number of occurrences of the plurality of discriminative features in the corresponding set of discriminative features 652, 662. In FIG. 6, the predetermined number of the discriminative features is two. However, the predetermined number may be any number, as per desired application attributes. In this example, the two of the discriminative features 654 from the set of discriminative features 652 are selected and the two of the discriminative features 664 from the set of discriminative features 662 are selected based on the number of occurrences of the plurality of discriminative features in the corresponding set of discriminative features 652, 662. Further, the selected discriminative features 654, 664 from each set of discriminative features 652, 662 are collated to form the plurality of key discriminative features 654, 664.

The set of test power distributions (e.g., Ex. 10 to Ex. N) is further divided into a plurality of subsets of test power distributions 642, 644, such that each of the plurality of subsets of test power distributions 642, 644 includes at least one test power distribution having the poor quality indicator P as the predetermined quality indicator 610.

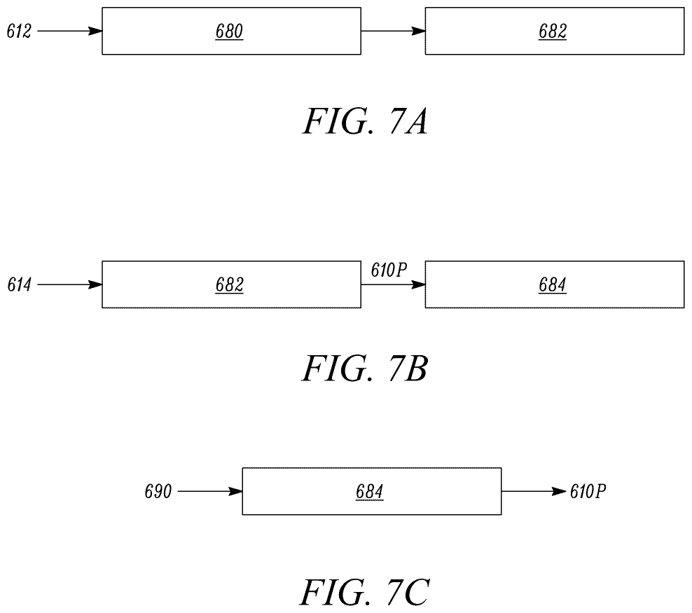

FIG. 7A shows a schematic block diagram of a predictive model 680.

In some embodiments, the predictive model 680 is trained by using the plurality of key discriminative features 654, 664 of the set of training power distributions of the training dataset 612 to generate the trained predictive model 682. As discussed above, in some embodiments, the predictive model 680 may be the machine learning model or the decision tree classification model.

FIG. 7B shows a schematic block diagram of the trained predictive model 682.

In some embodiments, the trained predictive model 682 is validated by using the set of test power distributions of the test dataset 614 to generate the validated predictive model 684. In some embodiments, the trained predictive model 682 classifies each value of the plurality of key discriminative features 654, 664 of the test power distribution of the set of test power distributions (e.g., Ex. 10 to Ex. N) into one of the plurality of predetermined quality indicators 610. For example, the trained predictive model 682 classifies each value of the plurality of key discriminative features 654, 664 of the test power distribution of the set of test power distributions into a corresponding predetermined quality indicator 610P. The corresponding predetermined quality indicator 610P is one of the plurality of predetermined quality indicators 610. In some embodiments, the trained predictive model 682 is validated by comparing, for each of the test power distributions, the predetermined quality indicator 610P classified by the trained predictive model 682 with the predetermined quality indicator 610 in the test dataset 614.

In some embodiments, the trained predictive model 682 is validated using at least one evaluation criteria to determine the performance of the trained predictive model 682. In some embodiments, F1 score and/or accuracy of the trained predictive model 682 may be used as the evaluation criteria.

Table 1 provided below shows an exemplary confusion matrix depicting prediction results of the trained predictive model 682 for the test dataset 614. Specifically, the confusion matrix includes a count of each of actual predetermined quality indicators (i.e., the predetermined quality indicators 610) and a count of each of predicted predetermined quality indicators (i.e., the predetermined quality indicators 610P) for the test dataset 614.

TABLE 1

Predicted

| | | Good | Poor |
|---|---|---|---|
| Actual | Good | 77 | 3 |
| | Poor | 4 | 16 |

Table 2 provided below shows different evaluation parameters, such as the F1 score and the accuracy of the trained predictive model 682 for the test dataset 614 based on the confusion matrix provided in Table 1.

TABLE 2

| | Mean | Standard Deviation |
|---|---|---|
| Accuracy | 0.930 | 0.119 |
| F1-Score | 0.954 | 0.084 |

FIG. 7C shows a schematic block diagram of the validated predictive model 684.

In some embodiments, a plurality of input key discriminative features 690 is received, as per the step 220 of the method 200. Specifically, values of the plurality of input key discriminative features 690 may be provided to the validated predictive model 684 by the user via the user interface. In some embodiments, each of the plurality of input key discriminative features 690 is classified into one (e.g., 610P) of the plurality of predetermined quality indicators 610 by using the validated predictive model 684.

As discussed above, each of the plurality of input key discriminative features 690 is classified into one of the plurality of predetermined quality indicators. In some embodiments, each of the plurality of input key discriminative features 690 is classified into one of the plurality of predetermined quality indicators 610 by using the validated predictive model 684.

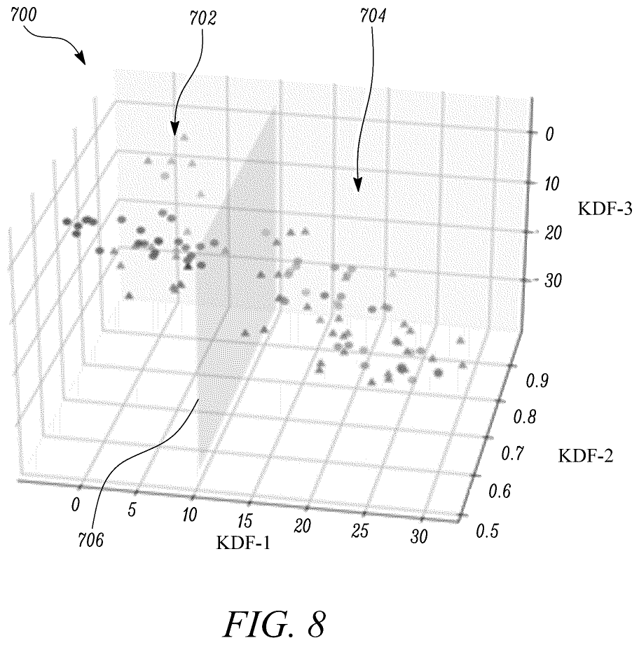

FIG. 8 illustrates an exemplary graphical representation 700 of at least one of the plurality of key discriminative features 654, 664 indicating the predetermined quality indicators 610 of the corresponding training power distributions of the training dataset 612. In the illustrated embodiment of FIG. 8, the at least one of the plurality of key discriminative features 654, 664 includes key discriminative features KDF-1, KDF-2, KDF-3. Specifically, values of the key discriminative features KDF-1, KDF-2, KDF-3 indicating the predetermined quality indicators 610 of the corresponding training power distributions of the training dataset 612 are plotted in the graphical representation 700. In some embodiments, the values of the key discriminative features KDF-1, KDF-2, KDF-3 may be represented using a different colour and/or shape. In some embodiments, the values of the key discriminative features KDF-1, KDF-2, KDF-3 may indicate the predetermined quality indicators 610 using a different colour and/or shape for the different predetermined quality indicators 610.

In some embodiments, one or more planes 706 are determined that separate the graphical representation 700 into a plurality of regions 702, 704 including a majority of the corresponding predetermined quality indicators 610. For example, the region 702 may include a majority of the good quality indicators G and the region 704 may include a majority of the poor quality indicators P. In some embodiments, one or more optimal values for the at least one of the plurality of key discriminative features 654, 664 is determined based on the one or more planes 706.

In an embodiment, the graphical representation 700 may be displayed on the user interface. In such embodiments, the user may select a type of representation, such as, a two-dimensional representation, a three-dimensional representation, or a four-dimensional representation. In some embodiments, the user may select the at least one of the plurality of key discriminative features 654, 664 to be displayed in the graphical representation 700. In other words, the user may interact with the graphical representation 700 to select the at least one of the plurality of key discriminative features 654, 664 to be displayed in the graphical representation 700. Therefore, the graphical representation 700 may be interactive.

As discussed above, each of the plurality of input key discriminative features 690 is classified into one of the plurality of predetermined quality indicators 610. In some embodiments, each of the plurality of input key discriminative features 690 is classified into one of the plurality of predetermined quality indicators 610 by using the one or more planes 706.

The power beam process is controlled based on the predetermined quality indicator 610 of each of the plurality of input key discriminative features 690. For example, the user may set the control parameters (e.g., the beam parameters) according to the predetermined quality indicator 610 of each of the plurality of input key discriminative features 690. Therefore, the method 200 of the present disclosure provides a robust, efficient, and fully data driven process of determining the key discriminative features 654, 664 and controlling the power beam process that facilitates repeatability of the power beam process for different components and machines performing the power beam process.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A method for controlling a power beam process, the method comprising:
carrying out a plurality of test power beam processes using a power beam on one or more test components;
determining a plurality of power distributions of the power beam corresponding to the plurality of test power beam processes, wherein each of the plurality of power distributions is a distribution of a beam intensity of the power beam with respect to a distance from a centre of the power beam;
determining a plurality of beam parameters of the power beam corresponding to each of the plurality of power distributions;
generating a plurality of derived features for each of the plurality of power distributions based on the plurality of beam parameters of the corresponding power distribution, wherein each of the plurality of derived features is obtained by combining two or more of the plurality of beam parameters of the corresponding power distribution;
determining a plurality of process characteristics of each of the plurality of test power beam processes;
classifying each of the plurality of power distributions into one of a plurality of predetermined quality indicators based on the plurality of process characteristics of the corresponding test power beam process;
generating a comprehensive dataset by consolidating the plurality of power distributions with the corresponding plurality of derived features, the corresponding plurality of beam parameters, the corresponding plurality of process characteristics, and the corresponding predetermined quality indicator;
dividing the comprehensive dataset into a test dataset and a training dataset that is mutually exclusive from the test dataset, wherein the test dataset comprises a set of test power distributions from the plurality of power distributions, and wherein the training dataset comprises a set of training power distributions from the plurality of power distributions;
determining a plurality of key discriminative features from the plurality of derived features of the set of training power distributions;
receiving a plurality of input key discriminative features;
classifying each of the plurality of input key discriminative features into one of the plurality of predetermined quality indicators; and
controlling the power beam process based on the predetermined quality indicator of each of the plurality of input key discriminative features.

2. The method of claim 1, wherein the plurality of predetermined quality indicators comprises at least a good quality indicator and a poor quality indicator; the method further comprising dividing the set of test power distributions into a plurality of subsets of test power distributions, such that each of the plurality of subsets of test power distributions comprises at least one test power distribution having the poor quality indicator as the predetermined quality indicator.

3. The method of claim 1, wherein determining the plurality of key discriminative features further comprises:
dividing the set of training power distributions into a plurality of subsets of training power distributions, each of the plurality of subsets of training power distributions having the plurality of derived features of the corresponding training power distributions;
determining a set of discriminative features from the plurality of derived features of each of the plurality of subsets of training power distributions by performing descriptive analytics on the plurality of derived features of the corresponding subset of training power distributions, each set of discriminative features comprising a plurality of discriminative features selected from the plurality of derived features;
selecting a predefined number of the discriminative features from each set of discriminative features based on a number of occurrences of the plurality of discriminative features in the corresponding set of discriminative features; and
collating the selected discriminative features from each set of discriminative features to form the plurality of key discriminative features.

4. The method of claim 1, further comprising:
training a predictive model by using the plurality of key discriminative features of the set of training power distributions; and
validating the trained predictive model by using the set of test power distributions.

5. The method of claim 4, wherein validating the trained predictive model further comprises:
providing the test dataset to the trained predictive model;
classifying, via the trained predictive model, each value of the plurality of key discriminative features of the test power distribution of the set of test power distributions into one of the plurality of predetermined quality indicators; and
validating the trained predictive model by comparing, for each of the test power distributions, the predetermined quality indicator classified by the trained predictive model with the predetermined quality indicator in the test dataset.

6. The method of claim 5, wherein validating the trained predictive model further comprises using at least one evaluation criteria to determine a performance of the trained predictive model.

7. The method of claim 5, wherein each of the plurality of input key discriminative features is classified into one of the plurality of predetermined quality indicators by using the validated predictive model.

8. The method of claim 1, wherein a focus current or a working distance of the power beam is different across the plurality of test power beam processes.

9. The method of claim 1, wherein the plurality of beam parameters comprises at least one of a Full Width Half Maximum of the power beam, a peak power of the power beam, a beam diameter of the power beam, a beam area of the power beam, a beam intensity of the power beam, a beam angle of the power beam, and a beam circularity of the power beam.

10. The method of claim 1, further comprising:
generating a graphical representation of at least one of the plurality of key discriminative features indicating the predetermined quality indicators of the corresponding training power distributions; and
determining one or more planes that separate the graphical representation into a plurality of regions comprising a majority of the corresponding predetermined quality indicators.

11. The method of claim 10, wherein each of the plurality of input key discriminative features is classified into one of the plurality of predetermined quality indicators by using the one or more planes.

12. The method of claim 10, further comprising determining one or more optimal values for the at least one of the plurality of key discriminative features based on the one or more planes.

13. The method of claim 1, further comprising cleaning the comprehensive dataset prior to dividing the comprehensive dataset into the test dataset and the training dataset, wherein cleaning the comprehensive dataset comprises removing duplicate power distributions from the plurality of power distributions.

14. The method of claim 1, wherein generating the comprehensive dataset further comprises consolidating the plurality of power distributions with a corresponding timestamp of the corresponding test power beam process.

15. The method of claim 1, wherein the power beam is an electron beam.

16. The method of claim 1, wherein the power beam process is an electron beam welding process.

17. The method of claim 16, wherein the plurality of process characteristics comprises at least one of a weld depth and a weld width.

18. A computing device comprising a processor and a memory having stored therein a plurality of instructions that when executed by the processor causes the computing device to perform the method of claim 1.

19. A non-transitory computer-readable storage medium comprising instructions that, when executed, cause at least one processor to perform the method of claim 1.
